(19) United States
(12) Patent Application Publication
(10) Pub. No.: US 2013/0041725 A1
(43) Pub. Date: Feb. 14, 2013

(54) METHOD AND APPARATUS FOR DYNAMIC VENDOR REWARDS PROGRAMS

(71) Applicants: Devin C. Moore, Lewis Center, OH (US); Wade P. Thompson, Moore, SC (US)

(72) Inventors: Devin C. Moore, Lewis Center, OH (US); Wade P. Thompson, Moore, SC (US)

(73) Assignee: VERIZON PATENT AND LICENSING INC., Basking Ridge, NJ (US)

(21) Appl. No.: 13/208,089

(22) Filed: Aug. 11, 2011

(51) Int. Cl. G06Q 30/00

(52) U.S. Cl. 705/14.1

(57) ABSTRACT

An approach is provided for providing dynamic vendor rewards programs. Information corresponding to rewards programs of a plurality of vendors and information corresponding to a user are stored in a database, wherein the database is maintained by a service provider. A rewards offer is retrieved from the database based on a transaction between one of the plurality of vendors and the user. Presentation of the rewards offer to the user via a user device.

### BACKGROUND INFORMATION

Service providers are continually challenged to deliver value and convenience to consumers by providing compelling network services and advancing the underlying technologies. Additionally, vendors of goods and/or services are continually challenged to attract customers to their goods and/or services in increasingly competitive markets by providing rewards programs to their customers. Current rewards programs are offered by a variety of different vendors, and require consumers to join rewards programs at each individual vendor to take advantage of such programs. Additionally, such vendor rewards programs typically require the customer to carry a card that identifies the customer in the vendor's system, and thus customers may be required to carry numerous different cards to participate in numerous different rewards programs.

Based on the foregoing, there is a need for simplification of such rewards programs for consumers and vendors.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system for enabling a dynamic vendor rewards program, according to an exemplary embodiment;

FIG. 2 is a diagram of a rewards program platform configured to manage a dynamic vendor rewards program, according to an exemplary embodiment;

FIG. 3 is a diagram of a user device for use with a system for enabling a dynamic vendor rewards program, according to an exemplary embodiment;

FIG. 4A is a workflow process executed by a user to subscribe to a dynamic vendor rewards program, and FIG. 4B is a workflow process executed by a vendor to join a dynamic vendor rewards program, according to various embodiments;

FIG. 5A is a process of providing a dynamic vendor rewards program to a user on the basis of transactions between the user and a vendor, FIG. 5B is a process of providing a dynamic vendor rewards program to a user on the basis of input from the user, and FIG. 5C is a process of providing a dynamic vendor rewards program to a user on the basis of the user selectively providing information to a service provider, according to various embodiments;

FIG. 6 is a diagram of a user device for use with a system for enabling a dynamic vendor rewards program, according to an exemplary embodiment;

FIG. 7 is a diagram of a computer system that can be used to implement various exemplary embodiments; and

FIG. 8 is a diagram of a chip set that can be used to implement various exemplary embodiments.

### DESCRIPTION OF THE PREFERRED EMBODIMENT

An apparatus, method and software for enabling a dynamic vendor rewards program are described. In the following description, for the purposes of explanation, numerous specific details are set forth to provide a thorough understanding of the present invention. It is apparent, however, to one skilled in the art that the present invention may be practiced without these specific details or with an equivalent arrangement. In other instances, well-known structures and devices are shown in block diagram form to avoid unnecessarily obscuring the present invention.

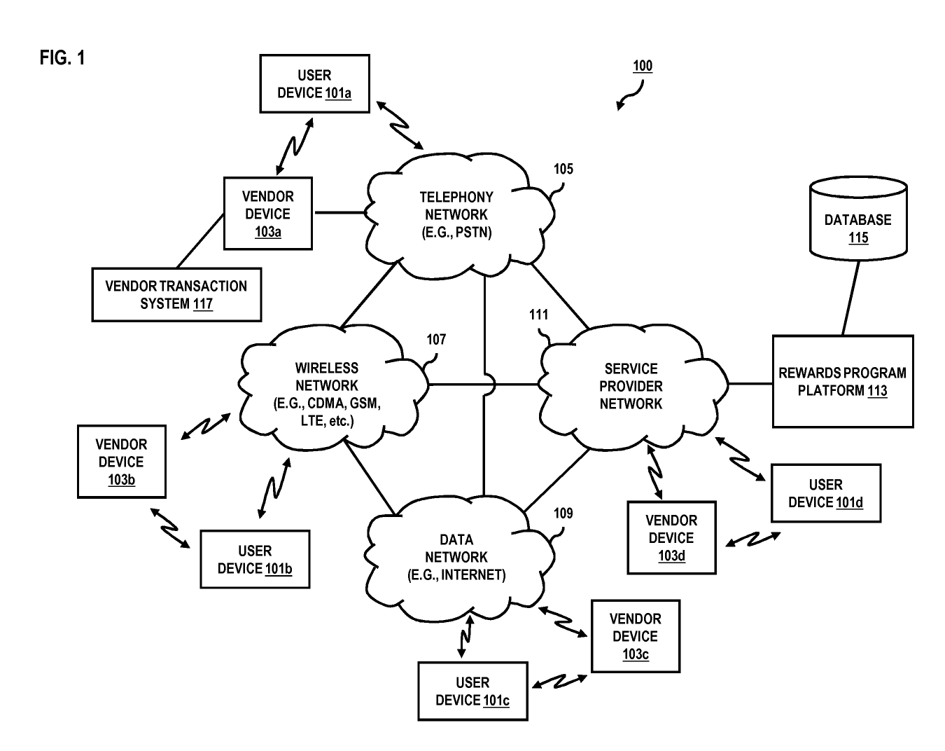

FIG. 1 is a diagram of a system for enabling a dynamic vendor rewards program, according to one embodiment. For the purpose of explanation, system 100 is shown to include one or more user devices 101a-101d (e.g., mobile device, smart phone, netbook, laptop, set-top box, or any communications enabled computing device) that are configured to communicate with one or more vendor devices 103a-103d (e.g., wired or wireless communication devices, near-field communication devices, barcode scanners/printers, Radio Frequency Identification (RFID) systems, etc.) and with a service provider via one or more networks, such as a telephony network 105, a wireless network 107, a data network, and a service provider network 111. The vendor devices 103a-103d can be used by a supplier of goods and/or services (e.g., merchants, retailers, wholesalers, etc.) during a purchase transaction (e.g., at a point-of-sale (POS), etc.). The term “vendor” used herein, according to certain embodiments, broadly encompasses any supplier of goods and/or services (e.g., merchants, retailers, wholesalers, service providers, etc.).

A rewards program platform 113, as managed by the service provider, to provide a retailer rewards program across multiple vendors for use by one or more users (e.g., subscribers). In other words, unlike traditional systems that support individualized, non-integrated rewards programs, the platform 113 can serve as a clearinghouse of sorts for the several vendors, thereby providing in effect a universal rewards program. Various rewards programs are made available to the users by the rewards program platform 113, and according to certain embodiments, can be provided in form of a physical and/or electronic coupon and/or other electronic reward. In one embodiment, the platform 113 is maintained by a service provider (e.g., a wireless communication company) as a hosted or subscription based service made available to users of devices 101a-101d through a service provider network 111. By way of example, the rewards program platform 113 enables the service provider, individual users of devices 101a-101d subscribed with the service provider, and a network of vendors to exchange information (e.g., coupon information, user information, vendor information, etc.) to provide deals of potential interest to the users. In some embodiments, the term “reward” used herein broadly encompasses an offer, incentive, discount, deal, or any other program provided by a vendor for encouraging or enticing a user to purchase a good and/or service. By way of example, information representative of or pertaining to a reward may include a discount percentage or price reduction, details regarding the product and/or service being offered, details regarding the vendor, expiration dates, participating store locations, a discount code, etc.

The system 100 of FIG. 1 enables users of user devices, such as mobile phones and smartphones, to readily utilize the device during transactions with vendors or other triggering events. In addition, the system 100 provides an approach of presenting rewards to users. By way of example, a rewards program platform 113 interacts with user devices 101a-101d and/or vendor devices 103a-103d to enable reward offers to be made available by a vendor to users. Under one scenario, when a user of device 101a purchases goods and/or services from a vendor via vendor device 103a, such as a point-of-sales (POS) terminal, the user can automatically be notified on the user device 103a via the rewards program sharing platform 113 of any rewards offers available based on that transaction. For example, the vendor that was a party to the transaction may provide the user with a coupon for a future purchase, or another vendor in the area may provide the user with a coupon for a purchase at that vendor's store. The rewards offer may be received as a short simple message (SMS), e-mail, a web-service based message or a as a pop-up message invoked by an application operable on the user device 101a. Additionally, it is noted that the rewards program platform 113 can operate directly in conjunction with vendor and user devices, and/or can further operate in conjunction with a vendor transaction system 117, such as a dedicated rewards system for a particular vendor.

It is noted that user devices 101a-101d may be any type of mobile terminal, fixed terminal, or portable terminal including a mobile handset, station, unit, device, multimedia computer, multimedia tablet, Internet node, communicator, netbook, desktop computer, laptop computer, Personal Digital Assistants (PDAs), smartphone or any combination thereof. It is also contemplated that the user devices 101a-101d can support any type of interface for supporting the presentment or exchanging of data. In addition, user devices 101a-101d may facilitate various input means for receiving and generating information, including touch screen capability, keyboard and keypad data entry, voice-based input mechanisms and the like. Any known and future implementations of user devices are applicable. It is noted that in certain embodiments user devices 101a-101d may be configured to establish peer-to-peer communication sessions with each other using a variety of technologies—i.e., near field communication (NFC), Bluetooth, infrared, etc. Also, connectivity can be provided via a wireless local area network (LAN). By way of example, a group of user devices 101a-101d may be configured to a common LAN so that each device can be uniquely identified via any suitable network addressing scheme. For example, the LAN may utilize the dynamic host configuration protocol (DHCP) to dynamically assign “private” DHCP internet protocol (IP) addresses to each user device, i.e., IP addresses that are accessible to devices connected to the service provider network 111 as facilitated via a router.

In system 100, according to certain embodiments, one or more networks, such as telephony network 105, wireless network 107, data network 109, and/or service provider network 111, are provided to handle various communication sessions between user device 101a-101d, the vendor devices 103a-103d, and/or the rewards program platform 113. Networks 105, 107, 109, and 111 may be any suitable wireline and/or wireless network. For example, telephony network 105 may include a circuit-switched network, such as the public switched telephone network (PSTN), an integrated services digital network (ISDN), a private branch exchange (PBX), or other like network.

Wireless network 107 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), long term evolution (LTE), satellite, and the like. Meanwhile, data network 109 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 105, 107, 109, and 111 may be completely or partially contained within one another, or may embody one or more of the aforementioned infrastructures. For instance, service provider network 111 may embody circuit-switched and/or packet-switched networks that include facilities to provide for transport of circuit-switched and/or packet-based communications. It is further contemplated that networks 105, 107, 109, and 111 may include components and facilities to provide for signaling and/or bearer communications between the various components or facilities of system 100. In this manner, networks 105, 107, 109, and 111 may embody or include portions of a signaling system 7 (SS7) network, or other suitable infrastructure to support control and signaling functions.

The platform 113 stores information regarding the various rewards programs made available by the vendor(s) to the user(s) in a database 115. When a user is identified at a vendor device 103s-103d, such as a POS terminal, rewards offer data of interest to the user and relative to the vendor (or affiliates or cross-promotional vendors thereof) from which the purchase transaction is associated may be presented to the user device 101a. As discussed in further detail below, the rewards offer data can then be presented to the user interface of the user device 101a.

The vendor transaction system 117 is an operations management tool maintained by the vendor. By way of example, the system 117 may include one or more servers, computing agents, customer relationship management tools, software utilities, databases and corresponding data sets and other resources for supporting the operations of the vendor. The system 117 may also be configured to ensure proper management of online or in-store purchase transactions engaged by customers, as well as for ensuring proper reconciliation of purchase transactions against inventory, production, manufacturing, delivery, supply chain and other needs. In certain instances, the vendor transaction system 117 may provide for the interconnection of resources across geographic locations (e.g., multiple different retail stores), the interaction of multiple retailers (e.g., Retailer A in partnership with Retailer B) and the like. By way of this approach, rewards offer data from multiple different vendors on a wide variety of goods and/or services may be maintained by the vendor and can be utilized in conjunction with the rewards program platform 113.

While implementations may vary, for the purpose of illustration, the vendor devices, such as a point-of-sales (POS) terminal, may be presented to a user (customer) as an interface for enabling purchase transactions to be handled, and can communicate with the rewards program platform 113 to manage rewards offers from the vendor (or other vendors) to the user based on the transaction. In one embodiment, the vendor devices 103a-103d are computerized devices for conducting a financial or payment transaction in relation to a good and/or service. The vendor device can include, for example, functions for recording and tracking customer orders, processing credit and debit cards (e.g., featuring built-in payment acceptance and processing systems) and managing inventory and deliveries. In addition, the vendor device can connect to other systems and devices over a communication network, including those systems and devices directly within the environment of its operation (e.g., other POS systems or computers within the vendor location) as well as external systems. It may also be configured to enable communication with a user device 101a-101d using near field communication, Bluetooth, WiFi systems, Radio Frequency Identification (RFID) systems, or other wireless communication technologies. Of note, the vendor device may be implemented as a physical device resident at the location of a retailer, as an online transactional platform offered by the vendor transaction system 117, or a combination thereof. In the latter example, the user is able to engage purchase and payment transactions with the retailer by way of a web portal or browser application at a user device 101a.

To facilitate rewards program offers, the vendor transaction system 117 and/or the rewards program platform 113 also maintain(s) a consumer database (e.g., database 115 for the platform 113) regarding the various customers who make purchases from the vendor, and/or regarding various subscribers to the rewards program(s) managed by the rewards program platform 113 to which the subscriber subscribes. The consumer data pertaining to a given purchaser may be recalled or referenced by the vendor device at the time of sale to facilitate the purchase process. It is noted that the consumer data may be used to identify the purchaser at the time of transaction for facilitating rewards program offers.

At or after the time of sale or at another triggering event (e.g., when the user enters a shopping mall, movie theater, or other location), the user can identify himself/herself to the vendor and/or to the rewards program platform 113 by presenting a code or by receiving a code through the use of the user device 101a-101d. The code can be a barcode (e.g., a bimodal barcode), quick response (QR) code, numerical code, data code, etc., that can be relayed using wired or wireless communication technologies, scanning technologies, using user interfaces, manually, or using any other communication technique. For example, in one embodiment, the user device 101a can display a barcode that can be scanned by the vendor device 103a to identify the user, and that information, along with transaction information and vendor information can be sent to the rewards program platform 113 for processing such information to generate a reward offer. In such an embodiment, a single barcode on phone can tie into multiple rewards programs (e.g., as identified by the vendor doing the scanning, or as identified by the user at the rewards program platform). In another embodiment, upon performance of a transaction, the vendor device 103a can print a receipt for the user that includes barcode using a barcode printer, and the user can scan the barcode using the user device 101a to retrieve vendor information and transaction information. Also, the user device 101a can either store such information for possible later use or transmit such information along with the user information to the rewards program platform 113 to process such information to generate a reward offer. In yet another embodiment, a user can use the user device to scan a barcode presented by a vendor device at the entrance to a shopping mall (or other trigger event), and any vendors that subscribe to the rewards program platform 113 can present reward offers to the user based on that trigger event (e.g., present a coupon for 10% off your next purchase at Bob's Ice Cream Stand). The reward offers can be presented based on whatever criteria or with whatever restrictions the vendors desire. For example, the reward offers can be limited in time, non-transferrable, triggered based on the purchase of a specific product, triggered based on a specific dollar value spent, etc., etc. Additionally, the reward offer can provide cross-promotional between different vendors (e.g., upon purchase of a movie ticket at the XYZ Theater, the user may receive a coupon from an ice cream parlor located across the street from the XYZ Theater, or vice versa).

The system 100 provides a dynamic vendor rewards program that can allow a user to utilize a single account or code (e.g., as managed using a user device 101a-101d) to access and participate in rewards programs from a multiple vendors, without the need for carrying multiple rewards cards as with current rewards programs. Such an approach is not only advantageous to consumers, but is also advantageous to the vendors, since, if consumers are more likely to use the rewards programs, then vendor's will have a greater chance of enticing consumers to buy their goods and/or services using such a rewards program. Furthermore, the system 100 provides a dynamic vendor rewards program that can allow vendors to outsource the operation and management of a rewards program to a service provider, and provide the vendors with the ability to easily cross-promote with other vendors.

In certain embodiments, the vendor can define the rewards program in any manner desired by the vendor. The rewards program platform 113 can provide a vendor with the ability to establish the rewards program, for example, by providing a web-based interface that the vendor can access via the service provider network 111 to establish the rewards program for that vendor, and define the terms of the rewards program. Additionally, the rewards program platform 113 can manage various user accounts within that rewards program, to track the user's transaction with that vendor and any associated vendors (e.g., cross-promotional vendors or vendors that are related to that vendor). The rewards program platform 113 will also manage that user's account across all of the vendors that subscribe to the rewards program platform. The rewards program platform 113 can provide the user devices 101a-101d and/or vendor devices 103a-103d with the codes used to identify the users and vendors and transactions therebetween to the rewards program platform 113. Additionally, the transaction history for a particular user or for a particular account that contain information regarding multiple users linked to that account can be stored by the rewards program platform 113 as it corresponds to various vendors, so that the rewards program platform 113 can manage the rewards programs of the various vendors.

The vendor, according to some embodiments, can set criteria for the use of codes per user or per account to maintain control over the usage of the codes and associated rewards offers, for example to prevent over usage. For example, the vendor can define a maximum number of code scans per day, a maximum number of code scans per phone, set a limit on the number of code scans per household or account, or the vendor can allow for unlimited code scans.

The rewards program platform 113 can be configured to send an identification number to the user device for secondary validation. Thus, when the rewards offer is redeemed, the identification number can alert the vendor that the rewards can from the user device. Thus, various safeguards can be provided to keep users from abusing the rewards programs, or otherwise engaging in unauthorized use.

The rewards program platform 113 can send a rewards offer, such as a coupon, to a user device based on a reward program definition defined by the vendor and/or the service provider. The rewards offers can be sent directly to the user device, and/or to a home address, email address, via text message, SMS/MMS message, etc. The rewards offer can have a unique identification (ID) tied to the user. The rewards offer can be scanned at the point of sale, or the vendor employee can types in the rewards offer ID, or the user can provide an input (e.g., press a button on the user device) to redeem the code. When the coupon is scanned at the POS, the ID can be sent to the service provider rewards program platform 113 to tie the user to the redeemed coupon.

Moreover, the rewards program platform 113 can provide for rewards program aggregation. For example, rewards programs across different retailers can be combined and managed by the rewards program platform. A web interface can be provided that allows multiple vendors to create affiliations and share promotions. Such cross-promotions can be run in conjunction with the vendors individual rewards program. The vendors are able to design cross-promotional programs and other vendors can opt in. For example, a mall owner or individual vendor in the mall can create a cross-promotional rewards programs such that when a user enters a mall, the user can use the user device to scan a mall code. Each additional purchase at a different vendor can increase the awards level, which can be redeemed for cash back or various coupons or other promotions.

The service provider can manage the rewards program service on the user devices. The service provider can establish individual bar codes for each vendor subscribed to the service. In the meantime, rewards program usage data can be collected via a communication means, such as a near field communications system or other communication technology, at the store upon item purchases.

Users/subscribers can elect to trade their data access back to various vendors for coupons and other rewards, including cross-company rewards. The user usage data can be stored locally in the user device, to provide the user with greater control over the user or distribution of such data. For example, the users can choose to “sell back” their data access to various vendors if desired, in exchange for promotions or other rewards offers. The usage data could also provide a vendor that “backs back” such data with all consumer data for that user (e.g., from competing vendors).

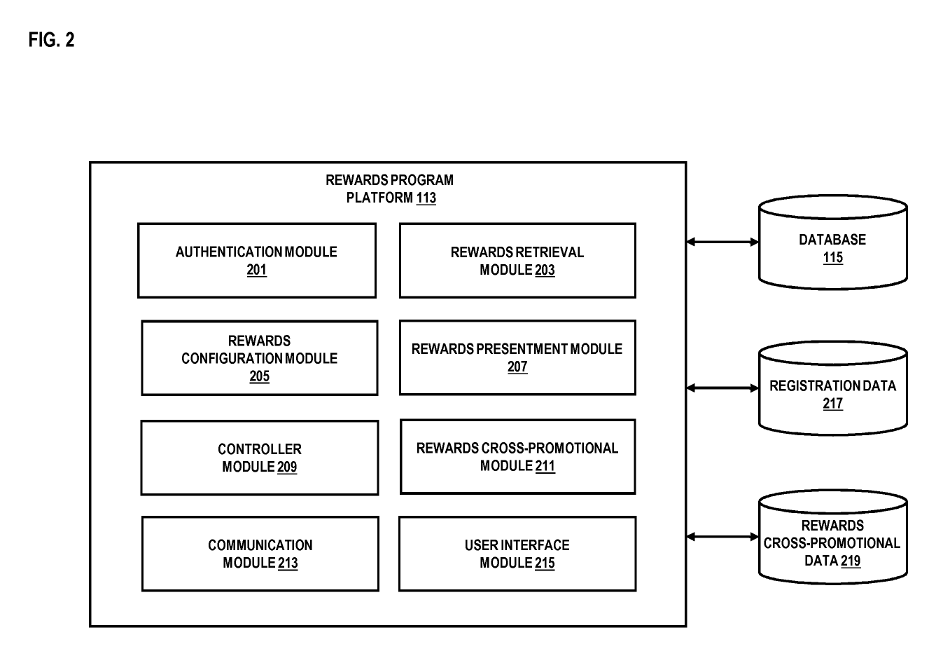

FIG. 2 is a diagram of a rewards program platform 113 configured to manage a dynamic vendor rewards program, according to an exemplary embodiment. The rewards program platform 113 includes various executable modules for performing one or more computing, data processing and network based instructions that in combination provide a means of enabling the provisioning of resources of a packetized voice communication solution provider. Such modules can be implemented in hardware, firmware, software, or a combination thereof. By way of example, the rewards program platform 113 may include an authentication module 201, rewards retrieval module 203, rewards configuration module 205, rewards presentment module 207, controller module 209, rewards cross-promotional module 211, communication module 213 and user interface module 215. In addition, the rewards program platform 113 also maintains rewards database 115 as received from various vendors (e.g., via a vendor transaction system 117), registration data 217 pertaining to the various subscribers to the rewards program platform 113 by way of the service provider, and rewards cross-promotional data 219 for storing information relating to cross-promotional rewards programs established by vendors.

In one embodiment, an authentication module 201 authenticates users and user devices 101a-101d for interaction with the rewards program platform 113. By way of example, the authentication module 201 receives a request from a user of a device 101 to subscribe to the rewards program service for enabling receipt of rewards offers. The subscription process may include enabling communication between the user device and a vendor device. Other settings may include specifying the method of communicating deals to the user device, such as e-mail, short messaging service (SMS) or as a web-based communication. In certain instances, the initial authentication process may also involve the downloading of a rewards program application (not shown)—i.e., for enabling rewards program features and controls—to respective user devices 101a-101d.

The authentication process performed by the module 201 may also include receiving and validating a login name and/or user identification value as provided or established for a particular user during a subscription or registration process with the service provider. The login name and/or user identification value may be received as input provided by the user from the user device or other device via a graphical user interface to the platform 113 (e.g., as enabled by user interface module 215). Alternatively, the login process may be performed through automated association of profile settings maintained as registration data 217 with an identification signal generated by an active device, i.e., a carrier detection signal or customer identifier value determined via a vendor device.

By way of example, the authentication module 201 receives messages from a vendor device 103a indicating a customer that is or has engaged in a purchase transaction. This message may be received from the vendor device based on the detection of a code registered to the customer via the user device 101a. It is noted, therefore, that the authentication process of module 201 may include determining if the customer has registered to receive rewards offers. In addition, the authentication module 201 also receives messages from the vendor device indicating a customer that is or has engaged in a purchase transaction. As part of the authentication process, therefore, the authentication module 201 checks to see if the customer has registered to receive rewards offers based on their purchase transaction.

In one embodiment, the rewards retrieval module 203 retrieves rewards offer the vendor's rewards program. In addition, the rewards offer may specify terms, conditions, purchase pricing, product information (in the form of either audio, textual, visual, or a combination thereof) and other data useful for informing the user about the rewards offer. The particular set of reward offer data made available for presentment at user devices 101a-101d depends on criteria or preferences as established by the user, as well as rules and settings of the vendor in that vendor's rewards program as maintained on the rewards program platform 113.

In one embodiment, the rewards configuration module 205 is used by the vendors when establishing the rewards program, and defining the terms and condition of rewards offers under the rewards program. The vendors can access the rewards configuration module 205 via a web-based portal, or the vendor can provide the service provider with the terms and conditions, for example, via telephone or paper forms, such that the service provider can enter such terms and conditions using the rewards configuration module 205.

In one embodiment, a rewards presentment module 207 operates in connection with the user interface module 215 to enable presentment of rewards offer data, as customized for the specific user and/or vendor in accordance with their configuration settings. By way of example, the deal presentment module 207 may cause a message to be generated at the user's user device, such as for reiterating the details of a purchase transaction (e.g., presentment of a receipt) and providing the user with a coupon for a future purchase. As another example, the deal presentment module 207 may cause a message to be generated for indicating special offers for the user from other vendors in cross-promotional rewards programs. The transmission process may be performed in conjunction with a communication module 213. Rewards communications may be in the form of a short simple message (SMS), e-mail or in other instances, a pop-up message; the form of the message may vary depending on the preferences of respective device users. Details regarding the nature of the rewards offer may also be conveyed, including how long the offer is available, if it is sharable before/after a purchase, the number of users the offer can be shared with, a comparison indicating pricing for the same items across similar retailers, etc.

In one embodiment, a rewards cross-promotional module 211 monitors transactions or other trigger events for users/subscribers to the rewards program platform 113, and determines whether cross-promotional rewards programs of the various vendors are applicable to such transactions or events. When such transactions or events occur that are applicable to the cross-promotional rewards programs, then the rewards cross-promotional module 211 provides the user with a rewards offer based on such transactions or events. For example, when a user purchases a ticket to movie theater, such a purchase can trigger a cross-promotional rewards offer from a local ice cream parlor, which causes the rewards program platform 113 to provide the user with a coupon for discounted ice cream.

In one embodiment, a controller module 209 is configured to regulate the communication processes between the various other modules. For example, the controller module 209 generates the appropriate signals to control the communication module 213 and rewards presentment module 207 for facilitating transmission of data over the service provider network 111. In one embodiment, the communication module 213 also enables formation of a session over the network 111 between the rewards program platform 113 and a portal application or web browser configured for execution at a user interface of a device 101a-101d. By way of example, the module 213 executes various protocols and data sharing techniques for enabling collaborative execution between a user device 101a-101d (e.g., mobile devices, laptops, smartphones, tablet computers, desktop computers) and the rewards program platform 113 over the service provider network 111.

It is noted that the communication module 213 may also be configured to exchange data with the vendor transaction system 117, such as in connection with the rewards retrieval module 203 for retrieving rewards data. In addition, the communication module 213 may also be configured to periodically send the rewards offer data generated to the vendor transaction system 117. By way of this approach, the rewards offer data may be analyzed by the vendor for generating reports or for providing intelligence that enables refinement of the rewards program, sales strategies, target marketing efforts and product offerings (e.g., elimination of unpopular deals and products). It is noted that the rewards offer response tendencies and patterns exhibited by respective purchasers may prove useful for facilitating development of larger scale television, radio and media campaigns.

As mentioned above, in one embodiment the user interface module 215 enables presentment of a graphical user interface on a user device. By way of example, the user interface module 215 generates a user interface in response to application programming interfaces (APIs) or other function calls corresponding to the web browser or web portal application of the user device for enabling display of graphical and textual elements. It is noted the user interface is generated at the purchaser's user device to enable viewing of rewards offers or for exchanging codes with the vendor device pursuant to execution of a purchase transaction with a vendor.

Of note, the above described modules may also perform similarly described functions in connection with a vendor subscribed to or associated with the rewards program platform 113 by way of the service provider. For example, the authentication module 201 may perform various functions for authenticating vendors and service providers wishing to publish rewards offers. As another example, the communication module 213 and user interface module 215 may be configured by a vendor for enabling specific content (e.g., retailer specific logos, color schemes, brand materials, etc.) to be transmitted and presented to a user device. Ultimately, the rewards program platform 113 enables proper execution, management and sharing of rewards offers with respect to all parties to a transaction, including users and vendors.

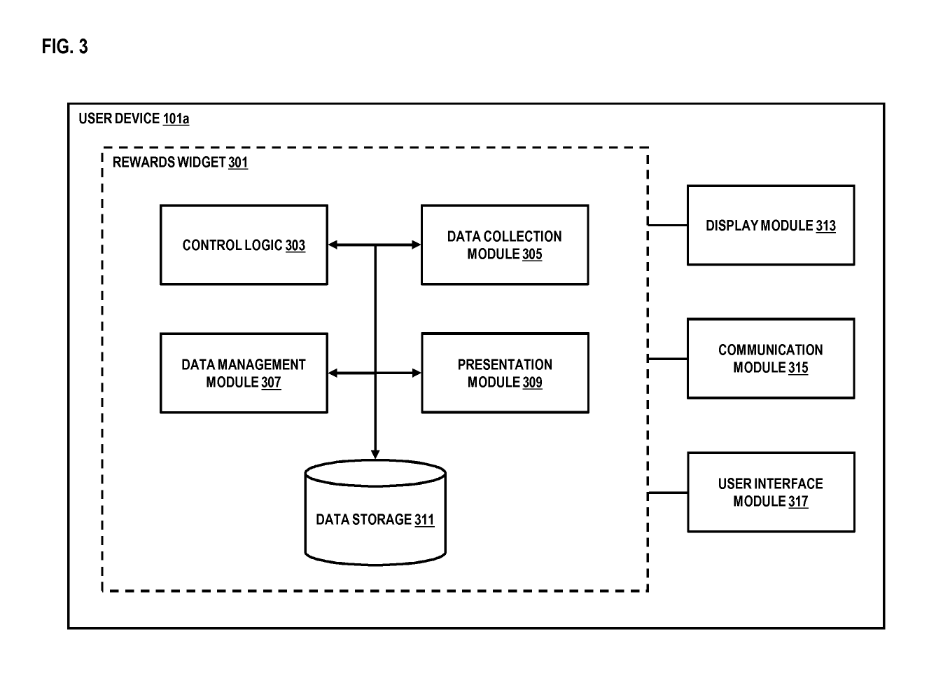

FIG. 3 is a diagram of a user device 101a for use with a system for enabling a dynamic vendor rewards program, according to an exemplary embodiment. The user device can be any type of computing device configured to communicate with the vendor devices in the manner discussed herein. In this embodiment, the user device 101a can be a mobile communication device, such as a smartphone, having a rewards widget 301, such as a software application loaded and running on the user device 101a. The rewards widget 301 can interact with a control logic module 303, a data collection module 305, a data management module 307, a presentation module 309, and a data storage 311. The control logic 303 is configured to control the operation of the rewards widget 301, and its interaction with other components of the user device 101a. The data collection module 305 is configured to gather data regarding purchase transactions and trigger events, as well as rewards offer data presented to the user. The data management module 307 is configured to control the flow and storage of data amongst the modules, and can be configured by user settings to control the overall operation of the rewards widget 301. The presentation module 309 is configured to present or display rewards offers to the user, and/or to present codes of the user to vendors.

The user device 101a further includes a display module 313, a communication module 315, and a user interface module 317. The display module 313 can be used in conjunction with the presentation module 309 to present rewards offers to the user via a display screen on the user device 101a. The communication module 315 is used in conjunction with the data collection module 305 and/or the presentation module 309 to communicate with the rewards program platform 113 and the vendor devices 103a-103d to transmit or receive data. The user interface module 317 is configured to allow the user to input data and control the operation of the rewards widget 301.

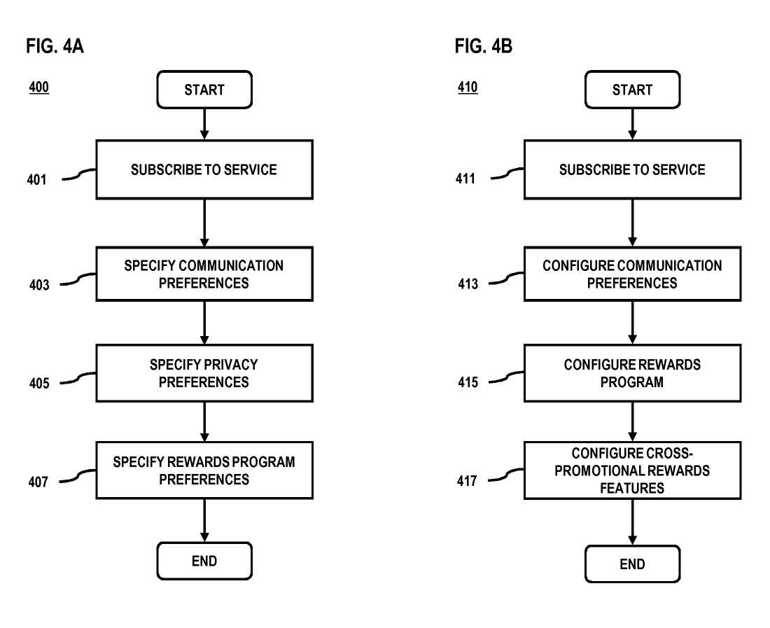

FIG. 4A is a workflow process 400 executed by a user to subscribe to a dynamic vendor rewards program, and FIG. 4B is a workflow process 410 executed by a vendor to join a dynamic vendor rewards program, according to various embodiments.

In FIG. 4A, process 400 pertains to a subscriber (user) subscribing to a reward program to receive rewards offers from vendor(s). In step 401, the user subscribes to the service, and can establish a user account, identification number, authorization settings, other authorized users to the account, manner in which the account can be accessed, etc. In step 403, the user specifies their communication preferences, such as whether they receive rewards offers or other account communications via email, text message, home mailing, etc. In step 405, the user specifies their privacy preferences, such as how much and what type of information (e.g., user information, transaction information, etc.) is shared with the vendor(s), and under what conditions information can be shared with vendor(s) (e.g., only upon authorization from the user). In step 407, the user specifies rewards program preferences, for example, by setting preferences regarding the types of or names of vendors that they want to receive rewards offers from, and/or types of offers that want to receive from vendor(s).

In FIG. 4B, process 410 pertains to a vendor subscribing to a reward program to have the reward program platform 113 manage a rewards program for that vendor. In step 411, the vendor subscribes to the service, and can establish a vendor account, identification number, authorization settings, other authorized vendors to the account, manner in which the account can be accessed, etc. In step 413, the vendor specifies their communication preferences, such as the manner in which rewards offers are sent to users, for example, via email, text message, home mailing, etc. In step 415, the vendor configures the rewards program, for example, by defining the terms and conditions of participation in the rewards program, and defining the specific rewards offers that are presented to users. In step 417, the vendor configures any cross-promotional rewards features, for example, by defining cross-promotional partnerships with other vendors, the terms and conditions of participation in the cross-promotional rewards program, and defining the specific rewards offers that are presented to users.

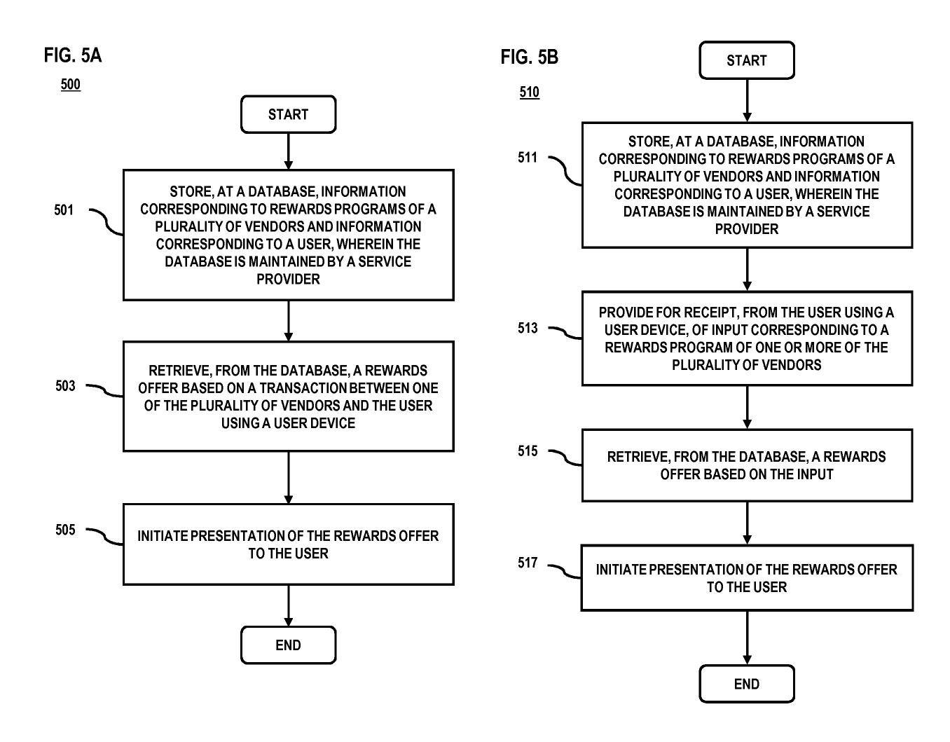

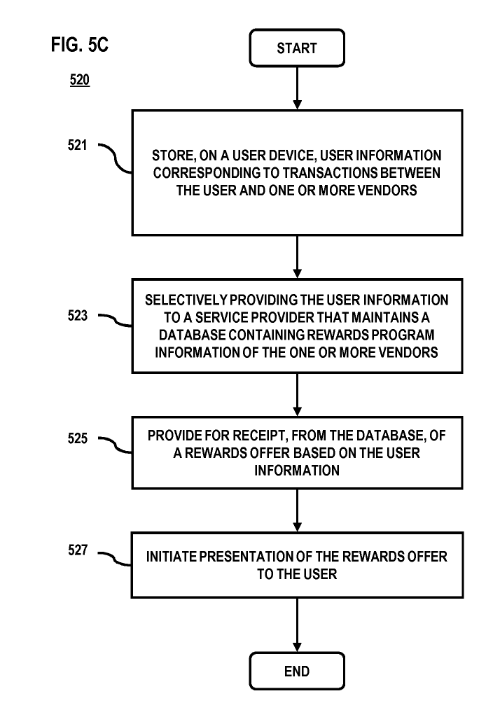

FIG. 5A is a process 500 of providing a dynamic vendor rewards program to a user on the basis of transactions between the user and a vendor, FIG. 5B is a process 510 of providing a dynamic vendor rewards program to a user on the basis of input from the user, and FIG. 5C is a process 520 of providing a dynamic vendor rewards program to a user on the basis of the user selectively providing information to a service provider, according to various embodiments.

While the embodiments in FIGS. 5A and 5B are described in terms of a service provider viewpoint and the embodiment in FIG. 5C is described in terms of a user device viewpoint, these processes can be performed by either or both of the service provider or the user device. Additionally, while the embodiments in FIGS. 5A-5C are described in terms of different trigger events that initiate the presentation of a rewards offer, these processes can be used individually or in combination with one another.

FIG. 5A is a process 500 of providing a dynamic vendor rewards program to a user on the basis of transactions between the user and a vendor. In step 501, information corresponding to rewards programs of a plurality of vendors and information corresponding to a user are stored at a database, such as database 115 connected to the rewards program platform 113 upon establishment of the user account and the vendor rewards program for that vendor. The database 115 and the rewards program platform 113 are maintained by a service provider. In step 503, a rewards offer is retrieved from the database based on a transaction between one of the plurality of vendors and the user using a user device. In step 505, presentation of the rewards offer to the user is initiated.

FIG. 5B is a process 510 of providing a dynamic vendor rewards program to a user on the basis of input from the user. In step 511, information corresponding to rewards programs of a multitude of vendors and information corresponding to a user are stored at a database, such as database 115 connected to the rewards program platform 113 upon establishment of the user account and the vendor rewards program for that vendor. The database 115 and the rewards program platform 113 are maintained by a service provider. In step 513, the rewards program platform 113 provides for receipt, from the user using a user device, of input corresponding to a rewards program of one or more of the vendors. For example, the input could be the user scanning a receipt from a vendor following a transaction, or the input could be a user scanning a code from a local vendor, for example, upon entering a mall or other location. In step 515, a rewards offer is retrieved from the database based on the input. In step 517, presentation of the rewards offer to the user is initiated.

FIG. 5C is a process 520 of providing a dynamic vendor rewards program to a user on the basis of the user selectively providing information to a service provider. In step 521, user information corresponding to transactions between a user and one or more vendors is stored on a user device. In step 523, the user information is selectively provided to a service provider that maintains a database containing rewards program information of the one or more vendors. This can allow the user to control when such user information is provided to the service provider, for example, by simply making a purchase or by actively authorizing the information to be transmitted at any given time. In step 525, the user device provides for receipt, from the database, of a rewards offer based on the user information. In step 527, presentation of the rewards offer to the user is initiated.

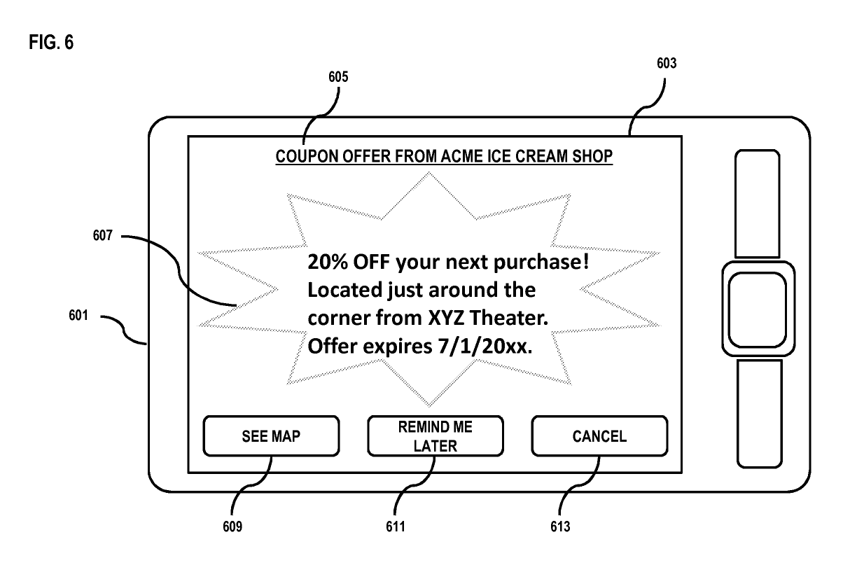

FIG. 6 is a diagram of a user device 601 for use with a system for enabling a dynamic vendor rewards program, according to an exemplary embodiment. The user device has a display 603 that presents a reward offer to the user. The rewards offer can include various descriptive indicia of the rewards offer. In FIG. 6, the rewards offer includes a header 605 that indicates that a coupon is being provided to the user by a specific vendor (i.e., ACME Ice Cream Shop), and a coupon 607 that describes the details regarding the rewards offer and limitations of the rewards offer. The display 603 could also depict a code such as a barcode (e.g., a bimodal barcode), quick response (QR) code, numerical code, data code, etc. that the vendor can scan (e.g., visually using a scanning device or manually, or using wireless or wired communication) to redeem the rewards offer, or data code, etc. The rewards widget on the user device 601 can also provide other useful information, such as a mapping application link 609. The rewards widget could also provide the user with a reminder button 611, or a cancellation button 613 that can be used to turn down the offer and/or exit the rewards widget.

The processes described herein for providing dynamic vendor rewards programs may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

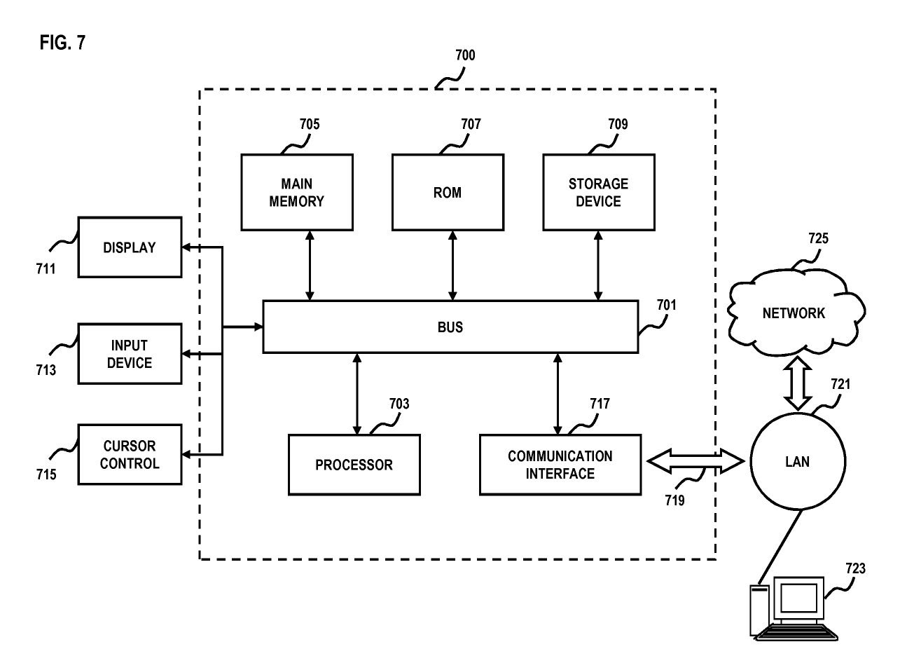

FIG. 7 is a diagram of a computer system that can be used to implement various exemplary embodiments. The computer system 700 includes a bus 701 or other communication mechanism for communicating information and one or more processors (of which one is shown) 703 coupled to the bus 701 for processing information. The computer system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions by the processor 703. The computer system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computer system 700 may be coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is a cursor control 715, such as a mouse, a trackball, or cursor direction keys, for communicating direction information and command selections to the processor 703 and for adjusting cursor movement on the display 711.

According to an embodiment of the invention, the processes described herein are performed by the computer system 700, in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the invention. Thus, embodiments of the invention are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, a telephone modem, or any other communication interface to provide a data communication connection to a corresponding type of communication line. As another example, communication interface 717 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communication network now commonly referred to as the “Internet”) or to data equipment operated by a service provider. The local network 721 and the network 725 both use electrical, electromagnetic, or optical signals to convey information and instructions. The signals through the various networks and the signals on the network link 719 and through the communication interface 717, which communicate digital data with the computer system 700, are exemplary forms of carrier waves bearing the information and instructions.

The computer system 700 can send messages and receive data, including program code, through the network(s), the network link 719, and the communication interface 717. In the Internet example, a server (not shown) might transmit requested code belonging to an application program for implementing an embodiment of the invention through the network 725, the local network 721 and the communication interface 717. The processor 703 may execute the transmitted code while being received and/or store the code in the storage device 709, or other non-volatile storage for later execution. In this manner, the computer system 700 may obtain application code in the form of a carrier wave.

The term “computer-readable medium” as used herein refers to any medium that participates in providing instructions to the processor 703 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 501. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

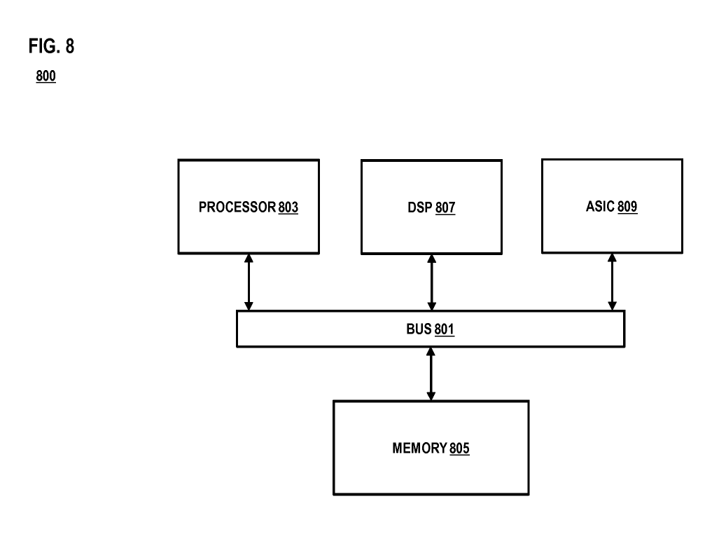

FIG. 8 illustrates a chip set or chip 800 upon which an embodiment of the invention may be implemented. Chip set 800 is programmed to enable a rewards program as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of placing and processing multi-vendor rewards programs.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to enable a dynamic vendor rewards program. The memory 805 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
storing, at a database, information corresponding to rewards programs of a plurality of vendors and information corresponding to a user, wherein the database is maintained by a service provider;
retrieving, from the database, a rewards offer based on a transaction between one of the plurality of vendors and the user; and
initiating presentation of the rewards offer to the user via a user device.

2. A method according to claim 1, further comprising:
receiving input from the one vendor relating to the transaction to initiate retrieval of the rewards offer.

3. A method according to claim 1, further comprising:
receiving input from the user device relating to the transaction to initiate retrieval of the rewards offer.

4. A method according to claim 3, wherein the input from the user is a code that identifies the one vendor and provides information regarding the transaction.

5. A method according to claim 1, wherein the rewards offer relates to goods and/or services offered by the one vendor.

6. A method according to claim 1, wherein the rewards offer relates to goods and/or services offered by another one of the plurality of vendors.

7. A method according to claim 1, further comprising:
receiving input from the plurality of vendors defining the rewards programs being offered by respective ones of the plurality of vendors.

8. A method according to claim 1, wherein the rewards offer is redeemable only by the user.

9. A method according to claim 1, wherein the user authorizes information regarding the transaction being sent to initiate retrieval of the rewards offer.

10. A method according to claim 1, further comprising:
receiving an input from the user requesting participation in the rewards program of the one or more of the plurality of vendors.

11. An apparatus comprising:
at least one processor; and
at least one memory including computer program code for one or more programs,
the at least one memory and the computer program code configured to, with the at least one processor, cause the apparatus to perform at least the following,
store, at a database, information corresponding to rewards programs of a plurality of vendors and information corresponding to a user, wherein the database is maintained by a service provider,
retrieve, from the database, a rewards offer based on a transaction between one of the plurality of vendors and the user, and
initiate presentation of the rewards offer to the user via a user device.

12. An apparatus according to claim 11, wherein the apparatus is further caused to:
receive input from the one vendor relating to the transaction to initiate retrieval of the rewards offer.

13. An apparatus according to claim 11, wherein the apparatus is further caused to:
receive input from the user device relating to the transaction to initiate retrieval of the rewards offer.

14. An apparatus according to claim 13, wherein the input from the user is a code that identifies the one vendor and provides information regarding the transaction.

15. An apparatus according to claim 11, wherein the rewards offer relates to goods and/or services offered by the one vendor.

16. An apparatus according to claim 11, wherein the rewards offer relates to goods and/or services offered by another one of the plurality of vendors.

17. An apparatus according to claim 11, wherein the apparatus is further caused to:
receive input from the plurality of vendors defining the rewards programs being offered by respective ones of the plurality of vendors.

18. An apparatus according to claim 11, wherein the rewards offer is redeemable only by the user.

19. An apparatus according to claim 11, wherein the user authorizes information regarding the transaction being sent to initiate retrieval of the rewards offer.

20. An apparatus according to claim 11, wherein the apparatus is further caused to:
receive an input from the user requesting participation in the rewards program of the one or more of the plurality of vendors.

21. A method comprising:
storing, on a user device of a user, user information corresponding to one or more transactions between the user and one or more vendors;
selectively providing the user information to a service provider that maintains a database containing rewards program information of the one or more vendors; and
providing for receipt, from the service provider, of a rewards offer based on the user information.

22. A method according to claim 21, wherein the user information is only provided to the service provider based on user authorization input into the user device.
